(19) United States
(12) Patent Application Publication
(10) Pub. No.: US 2024/0137187 A1
(43) Pub. Date: Apr. 25, 2024

(54) INTERFERENCE AVOIDANCE IN FULL DUPLEX COMMUNICATIONS

(71) Applicant: QUALCOMM Incorporated, San Diego, CA (US)

(72) Inventors: Yan ZHOU, San Diego, CA (US); Fang YUAN, Beijing (CN); Tao LUO, San Diego, CA (US)

(21) Appl. No.: 18/546,248

(22) PCT Filed: Apr. 28, 2021
(86) PCT No.: PCT/CN2021/090854

§ 371 Date: Aug. 10, 2023

(51) Int. Cl. H04L 5/00

(52) U.S. Cl. CPC H04L 5/0062; H04L 5/0094

(57) ABSTRACT

Certain aspects of the present disclosure provide techniques for interference avoidance in full duplex communications. A method that may be performed by a user equipment (UE) includes transmitting, to a network entity, a request to provide a configuration for interference avoidance between a first signal and a second signal, wherein the first signal is scheduled in a same transmission occasion as the second signal is scheduled for reception. The method further includes receiving, from the network entity, the configuration and configuring resources for at least one of transmission of the first signal or reception of the second signal in response to receiving the configuration. The method also includes transmitting the first signal via the configured resources and receiving the second signal in the transmission occasion.

### BACKGROUND

### Field of the Disclosure

Aspects of the present disclosure relate to wireless communications, and more particularly, to techniques for interference avoidance in full duplex communications.

### Description of Related Art

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. These improvements should be applicable to other multi-access technologies and the telecommunication standards that employ these technologies.

### SUMMARY

The systems, methods, and devices of the disclosure each have several aspects, no single one of which is solely responsible for its desirable attributes. After considering this discussion, and particularly after reading the section entitled “Detailed Description” one will understand how the features of this disclosure provide advantages that include desirable signal quality for received signals in full duplex communications.

Certain aspects of the subject matter described in this disclosure can be implemented in a method for wireless communication by a user equipment (UE). The method generally includes transmitting, to a network entity, a request to provide a configuration for interference avoidance between a first signal and a second signal, wherein the first signal is scheduled in a same transmission occasion as the second signal is scheduled for reception. The method further includes receiving, from the network entity, the configuration and configuring resources for at least one of transmission of the first signal or reception of the second signal in response to receiving the configuration. The method also includes transmitting the first signal via the configured resources and receiving the second signal in the transmission occasion.

Certain aspects of the subject matter described in this disclosure can be implemented in a method for wireless communication by a network entity. The method generally includes receiving, from a UE, a request to provide a configuration for interference avoidance between a first signal and a second signal, wherein the first signal is scheduled in a same transmission occasion as the second signal is scheduled for transmission. The method also includes transmitting, to the UE, the configuration and configuring resources for at least one of reception of the first signal or transmission of the second signal based at least in part on the configuration. The method further includes receiving the first signal via the configured resources and transmitting the second signal in the transmission occasion.

Certain aspects of the subject matter described in this disclosure can be implemented in an apparatus for wireless communication. The apparatus generally includes a memory, a processor, and a transceiver. The transceiver is configured to transmit, to a network entity, a request to provide a configuration for interference avoidance between a first signal and a second signal, wherein the first signal is scheduled in a same transmission occasion as the second signal is scheduled for reception. The transceiver is further configured to receive, from the network entity, the configuration. The processor is coupled to the memory, and the processor and memory are configured to configure resources for at least one of transmission of the first signal or reception of the second signal in response to receiving the configuration. The transceiver is configured to transmit the first signal via the configured resources and receive the second signal in the transmission occasion.

Certain aspects of the subject matter described in this disclosure can be implemented in an apparatus for wireless communication. The apparatus generally includes a memory, a processor, and a transceiver. The transceiver is configured to receive, from a UE, a request to provide a configuration for interference avoidance between a first signal and a second signal, wherein the first signal is scheduled in a same transmission occasion as the second signal is scheduled for transmission. The transceiver is further configured to transmit, to the UE, the configuration. The processor is coupled to the memory, and the processor and memory are configured to configure resources for at least one of reception of the first signal or transmission of the second signal based at least in part on the configuration. The transceiver is further configured to receive the first signal via the configured resources and transmit the second signal in the transmission occasion.

Certain aspects of the subject matter described in this disclosure can be implemented in an apparatus for wireless communication. The apparatus generally includes means for transmitting, to a network entity, a request to provide a configuration for interference avoidance between a first signal and a second signal, wherein the first signal is scheduled in a same transmission occasion as the second signal is scheduled for reception; means for receiving, from the network entity, the configuration; means for configuring resources for at least one of transmission of the first signal or reception of the second signal in response to receiving the configuration; means for transmitting the first signal via the configured resources; and means for receiving the second signal in the transmission occasion.

Certain aspects of the subject matter described in this disclosure can be implemented in an apparatus for wireless communication. The apparatus generally includes means for receiving, from a UE, a request to provide a configuration for interference avoidance between a first signal and a second signal, wherein the first signal is scheduled in a same transmission occasion as the second signal is scheduled for transmission; means for transmitting, to the UE, the configuration; and means for configuring resources for at least one of reception of the first signal or transmission of the second signal based at least in part on the configuration; means for receiving the first signal via the configured resources; and means for transmitting the second signal in the transmission occasion.

Certain aspects of the subject matter described in this disclosure can be implemented in a computer-readable medium. The computer-readable medium has instructions stored thereon for transmitting, to a network entity, a request to provide a configuration for interference avoidance between a first signal and a second signal, wherein the first signal is scheduled in a same transmission occasion as the second signal is scheduled for reception; receiving, from the network entity, the configuration; configuring resources for at least one of transmission of the first signal or reception of the second signal in response to receiving the configuration; transmitting the first signal via the configured resources; and receiving the second signal in the transmission occasion.

Certain aspects of the subject matter described in this disclosure can be implemented in a computer-readable medium. The computer-readable medium has instructions stored thereon for receiving, from a UE, a request to provide a configuration for interference avoidance between a first signal and a second signal, wherein the first signal is scheduled in a same transmission occasion as the second signal is scheduled for transmission; transmitting, to the UE, the configuration; and configuring resources for at least one of reception of the first signal or transmission of the second signal based at least in part on the configuration; receiving the first signal via the configured resources; and transmitting the second signal in the transmission occasion.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain aspects of this disclosure and the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for certain wireless communication systems (e.g., new radio (NR)), in accordance with certain aspects of the present disclosure.

FIG. 4 is a diagram illustrating an example of the interference that a UE may encounter in full duplex communications.

FIG. 5 is a flow diagram illustrating example operations for wireless communication by a UE, in accordance with certain aspects of the present disclosure.

FIG. 6 is a flow diagram illustrating example operations for wireless communication by a network entity, in accordance with certain aspects of the present disclosure.

FIG. 7 is a diagram illustrating an example of uplink rate matching in a full duplex transmission occasion, in accordance with certain aspects of the present disclosure.

FIG. 8 is a signaling flow diagram illustrating example signaling for configuring resources to avoid interference in full duplex communications, in accordance with aspects of the present disclosure.

FIG. 9 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for interference avoidance in full duplex communications. For example, a user equipment may be configured with a guard band or frequency separation between the frequency resources allocated for the full duplex uplink and downlink signals. In certain cases, the UE may be configured to rate match around frequency resources allocated for the downlink signal in mapping frequency resources for the uplink signal. The inference avoidance described herein may facilitate full duplex communications with desirable signal quality for the downlink signals. In aspects, the UE may be configured to perform the interference avoidance for certain signals, such as a positioning reference signal. The interference avoidance described herein may enable desirable measurement and/or positioning accuracy for the positioning reference signal.

The following description provides examples of a communication systems. Changes may be made in the function and arrangement of elements discussed without departing from the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth, millimeter wave mmW, massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

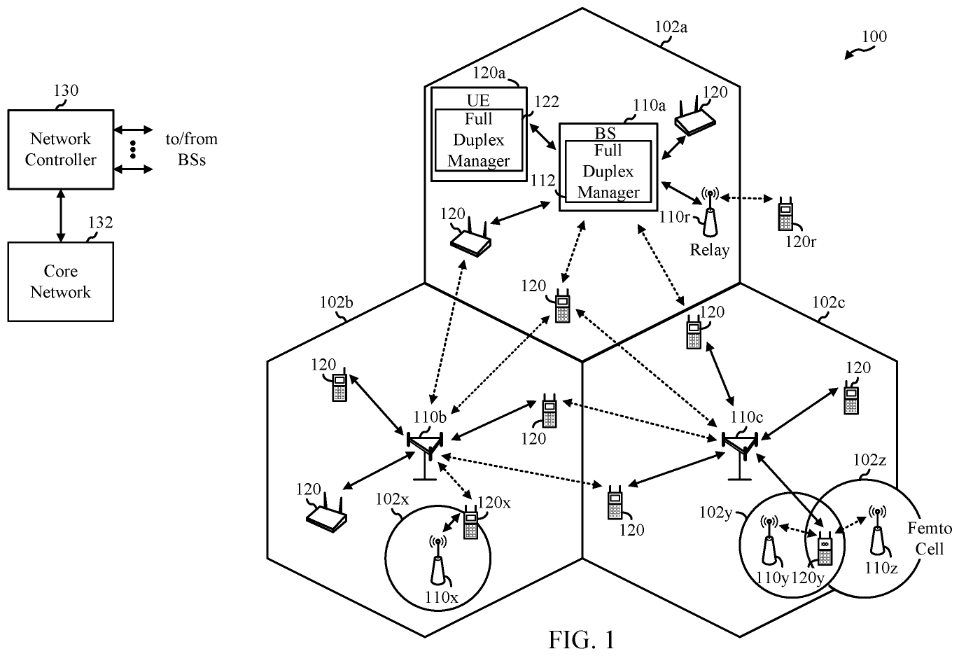

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more base station (BSs) 110a-z (each also individually referred to herein as BS 110 or collectively as BSs 110) and/or user equipment (UE) 120a-y (each also individually referred to herein as UE 120 or collectively as UEs 120) in the wireless communication network 100 via one or more interfaces.

As shown in FIG. 1, the BS 110a includes a full duplex manager 112 that may provide a UE with a configuration for interference avoidance (such as frequency separation, uplink rate matching, and/or a spatial configuration), in accordance with aspects of the present disclosure. The UE 120a includes a full duplex manager 122 that may request for a configuration for interference avoidance and/or configure resources in accordance with the configuration, in accordance with aspects of the present disclosure.

A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with UEs 120 in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In certain cases, the network controller 130 may include a centralized unit (CU) and/or a distributed unit (DU), for example, in a 5G NR system. In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

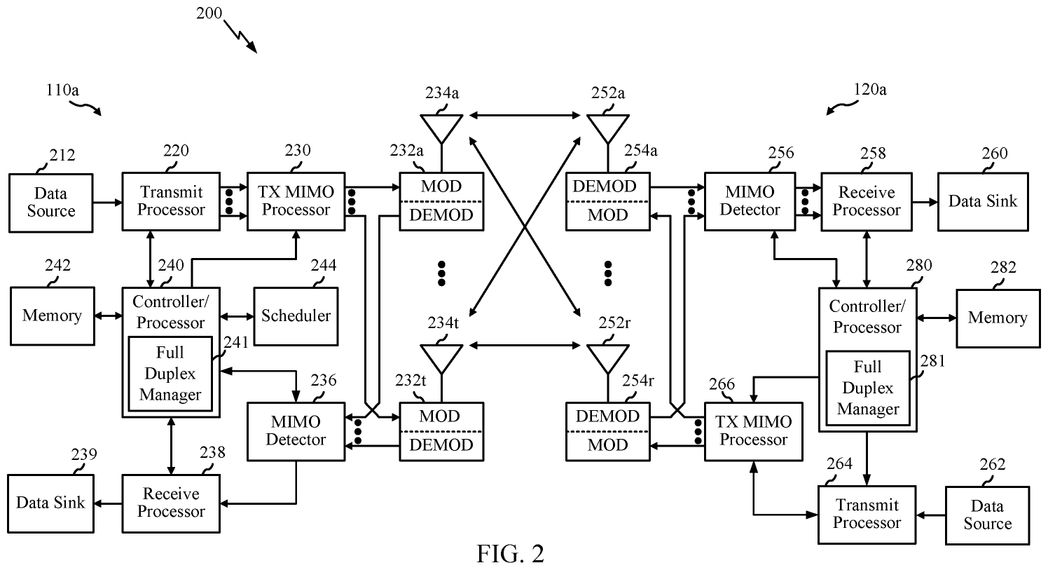

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 240 of the BS 110a has a full duplex manager 241 that may be representative of the full duplex manager 112, according to aspects described herein. As shown in FIG. 2, the controller/processor 280 of the UE 120a has a full duplex manager 281 that may be representative of the full duplex manager 122, according to aspects described herein. Although shown at the controller/processor, other components of the UE 120a and BS 110a may be used to perform the operations described herein.

While the UE 120a is described with respect to FIGS. 1 and 2 as communicating with a BS and/or within a network, the UE 120a may be configured to communicate directly with/transmit directly to another UE 120, or with/to another wireless device without relaying communications through a network. In some embodiments, the BS 110a illustrated in FIG. 2 and described above is an example of another UE 120.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

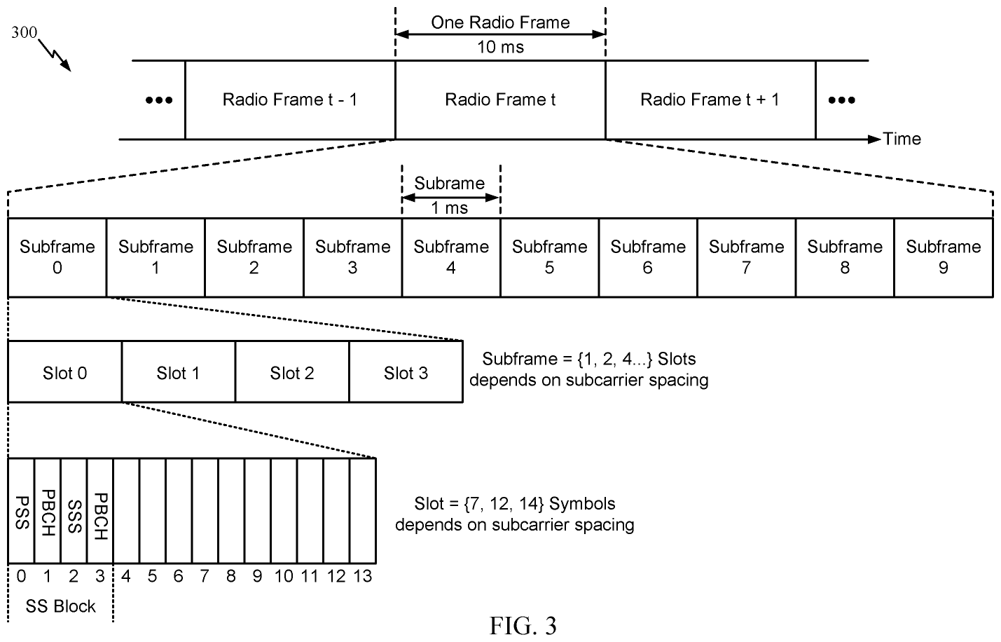

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A sub-slot structure may refer to a transmit time interval having a duration less than a slot (e.g., 2, 3, or 4 symbols). Each symbol in a slot may be configured for a link direction (e.g., downlink (DL), uplink (UL), or flexible) for data transmission and the link direction for each subframe may be dynamically switched. The link directions may be based on the slot format. Each slot may include DL/UL data as well as DL/UL control information.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst periodicity, system frame number, etc. The SSBs may be organized into an SS burst to support beam sweeping. Further system information such as, remaining minimum system information (RMSI), system information blocks (SIBs), other system information (OSI) can be transmitted on a physical downlink shared channel (PDSCH) in certain subframes. The SSB can be transmitted up to sixty-four times within an SS burst, for example, with up to sixty-four different beam directions for mmWave. The multiple transmissions of the SSB are referred to as an SS burst in a half radio frame. SSBs in an SS burst may be transmitted in the same frequency region, while SSBs in different SS bursts can be transmitted at different frequency regions.

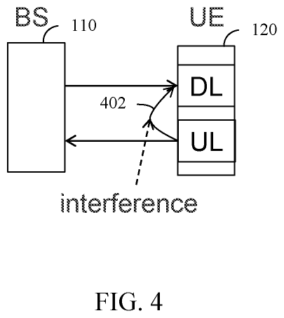

In certain wireless communication systems (e.g., 5G NR), full duplexing may be supported between the radio access network (RAN) and a UE. Full duplex communications may provide desirable spectrum efficiency. Self-interference may be encountered at a UE with full duplex communications. Uplink signals in full duplexing may interfere with the downlink signals in full duplexing. FIG. 4 is a diagram illustrating an example of the interference that a UE may encounter in full duplex communications. As shown, the UE 120 may be communicating with a BS 110 in a full duplex manner. That is, the UE 120 may be transmitting an uplink signal to the BS 110, and the BS 110 may be concurrently transmitting a downlink signal to the UE 120. Transmission of the uplink signal at the UE 120 may generate an interfering signal 402, which may interfere with the reception of the downlink signal at the UE 120. Accordingly, what is needed are techniques and apparatus for reducing or preventing interference encountered with full duplex communications.

### Example Interference Avoidance in Full Duplex Communications

Aspects of the present disclosure provide techniques and apparatus for interference avoidance in full duplex communications. For example, the UE may be configured with a guard band or frequency separation between the frequency resources allocated for the full duplex uplink and downlink signals. In certain cases, the UE may be configured to rate match around frequency resources allocated for the downlink signal in mapping frequency resources for the uplink signal. The inference avoidance described herein may facilitate full duplex communications with desirable signal quality for the downlink signals. In aspects, the UE may be configured to perform the interference avoidance for certain signals, such as a positioning reference signal. The interference avoidance described herein may enable desirable measurement and/or positioning accuracy for the positioning reference signal.

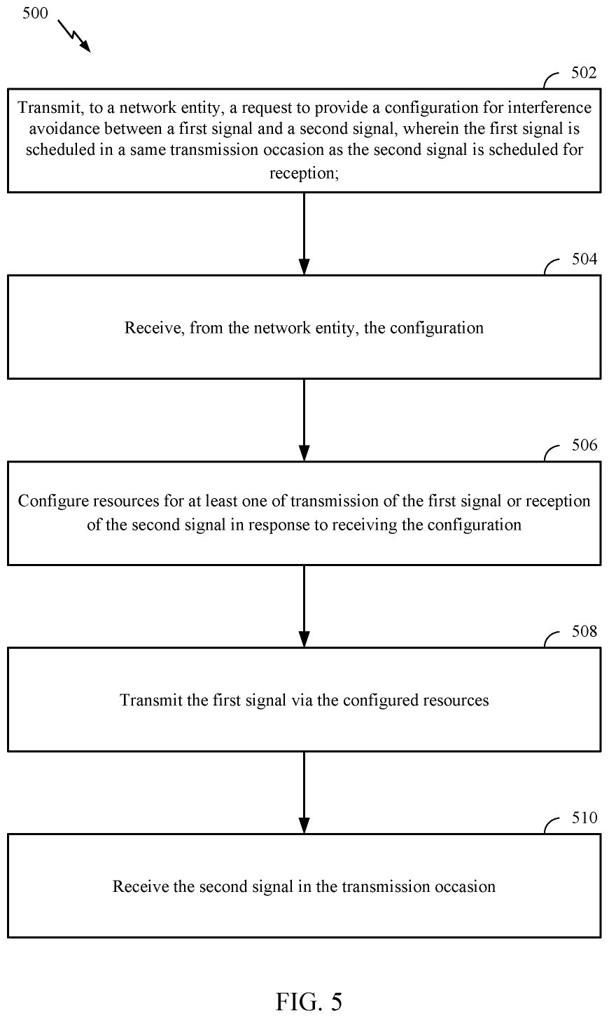

FIG. 5 is a flow diagram illustrating example operations 500 for wireless communication, in accordance with certain aspects of the present disclosure. The operations 500 may be performed, for example, by a UE (such as the UE 120a in the wireless communication network 100). The operations 500 may be implemented as software components that are executed and run on one or more processors (e.g., controller/processor 280 of FIG. 2). Further, the transmission and reception of signals by the UE in operations 500 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 500 may begin, at block 502, where the UE may transmit, to a network entity (e.g., BS 110), a request to provide a configuration for interference avoidance between a first signal and a second signal, where the first signal may be scheduled in a same transmission occasion as the second signal is scheduled for reception. In other words, the first and second signals are concurrently scheduled such that the UE is scheduled for full duplex communications. A transmission occasion may refer to a certain time period in which the UE is schedule to transmit or receive a signal. The transmission occasion may be a sequence of one or more symbols, mini-slots, and/or slots, such that the sequence may be formed from consecutive or non-consecutive time domain resources. As an example, the request may be a request for frequency separation between the first and second signals.

At block 504 the UE may receive, from the network entity, the configuration in response to the request. As an example, the configuration may indicate a set of frequency resources for the first signal, such that the first signal is separated from the second signal in the frequency domain, for example, by a guard band or a number of physical resource blocks in frequency domain. In aspects, the configuration may be received via downlink control signaling, such as downlink control information (DCI), radio resource control (RRC) signaling, medium access control (MAC) signaling, and/or system information. As used herein, the configuration may refer to a specific set of transmission parameters that may facilitate interference avoidance such as time domain, frequency domain, and/or spatial domain resources on which the UE may communicate for avoiding interference. The configuration may be semi-persistent, such that the configuration remains in effect until the configuration is updated or disabled. In aspects, the configuration may be set for a specific time period, such as one or more transmission occasions associated with a downlink signal and/or an uplink signal.

At block 506, the UE may configure resources for at least one of transmission of the first signal or reception of the second signal in response to receiving the configuration. For example, the UE may map frequency resources for the first signal by rate matching around the frequency resources allocated for the second signal. The resources configured at block 506 may include time domain and/or frequency domain resources. As used herein, configuring resources may include selecting time domain and/or frequency domain resources for transmission of the first signal and/or reception of the second signal.

At block 508, the UE may transmit the first signal via the configured resources. In certain cases, the UE may transmit the first signal in a different transmission occasion, such that the UE temporarily pauses full duplex communications during the transmission occasion, which may avoid self-interference for the second signal.

At block 510, the UE may receive the second signal in the transmission occasion. For example, the UE may receive a positioning reference signal in the transmission occasion, and the interference avoidance may be particularly desirable for reception of the positioning reference signal.

In certain aspects, the UE may request interference avoidance for certain full duplex symbol(s), a specific reference signal, and/or a specific channel. For example, the request at block 502 may be an explicit request that indicates the transmission occasion (e.g., in terms of symbols or one or more slots in the time domain) in which interference avoidance is requested. In certain cases, the request at block 502 may indicate a specific downlink reference signal that is requested for interference avoidance, for example, by an identifier associated with the reference signal.

For certain aspects, the request may be an implicit request for interference avoidance, for example, based on capability information associated with the UE provided to the network entity. In certain cases, the request may be included in an uplink scheduling (SR) message. In an SR message, the request may be implicit, for example, based on the transmission of the SR in response to previously received uplink scheduling.

In certain cases, the UE may request a time restriction for a network entity to not schedule any uplink transmission on certain full duplex symbols (such as symbols associated with a particular reference signal or channel). That is, the UE may request for half duplex communications for certain full duplex symbols. With respect to the operations 500, the request may indicate a time restriction to not schedule the first signal in the same transmission occasion with the second signal. At block 504, the configuration may indicate another transmission occasion for the first signal, where the other transmission occasion does not overlap with the transmission occasion at block 502. At block 508, the UE may transmit the first signal in the other transmission occasion.

For certain aspects, the UE may request for more separation between the downlink reception and the uplink transmission on full duplex symbols. With respect to the operations 500, the request may indicate to provide separation (e.g., frequency separation and/or spatial separation) between the first signal and the second signal, and the configuration may indicate the separation between the first signal and the second signal. At block 508, the UE may transmit the first signal in the transmission occasion with the separation indicated in the configuration.

In aspects, the UE may request for a guard band and/or frequency separation between the uplink and downlink signals. With respect to the operations 500, the request may indicate to provide frequency separation between the first signal and the second signal, and the configuration may indicate the frequency separation between the first signal and the second signal. At block 508, the UE may transmit the first signal in the transmission occasion with the frequency separation indicated in the configuration. For certain aspects, the frequency separation may include one or more guard bands in the frequency domain between the first signal and the second signal. For example, the frequency separation may be indicated as specific physical resource blocks in a bandwidth part of a carrier.

In certain aspects, the UE may request for an adjustment of the space division multiplexing (SDM) (e.g., beamforming) associated with the uplink and downlink signals. For example, the UE may request for partial spatial division multiplexing between the uplink and downlink signals to alleviate interference on non-overlapping parts. With respect to the operations 500, the request may indicate to adjust a SDM associated with the first and second signals, and the configuration may indicate a spatial parameter for at least the first signal. For example, the spatial parameter may include an angle of arrival (AoA), AoA spread, dominant AoA, average AoA, Power Angular Spectrum (PAS) of AoA, angle of departure (AoD), AoD spread, average AoD, PAS of AoD, transmit/receive channel correlation, transmit/receive beamforming, spatial channel correlation, etc. At block 508, the UE may transmit the first signal in the transmission occasion based at least in part on the spatial parameter indicated in the configuration. As an example, the UE may transmit the first signal via the beamforming indicated in the configuration.

For certain aspects, the UE may request that rate matching be enabled for mapping frequency resources for the uplink signal. That is, the UE may request for rate matching around at least part of the downlink assignment in mapping frequency resources for the uplink signal. With respect to the operations 500, the request may indicate to enable rate matching in a frequency domain for the first signal around the second signal, and the configuration may indicate that rate matching is enabled for the first signal. At block 508, the UE may transmit the first signal in the transmission occasion via one or more frequency resources rate matched around the second signal. For example, the UE may transmit the first signal in resources which are not included the indicated rate matching resources. That is, the UE may transmit the first signal in resources that do not overlap with resources allocated for the second signal.

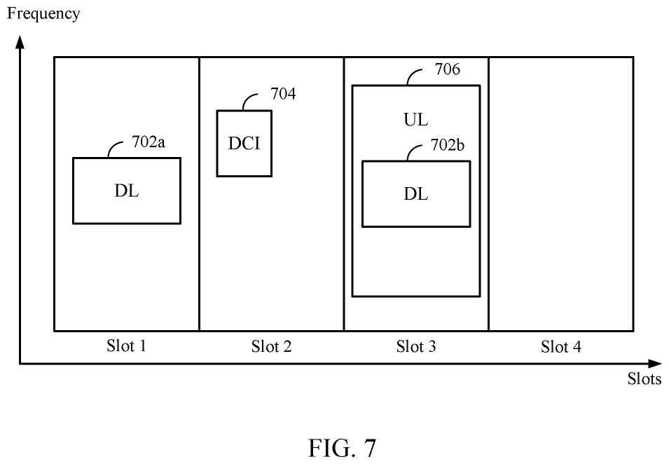

In certain aspects, the network entity may indicate an uplink rate matching pattern for the UE, for example, when scheduling an uplink transmission to the UE in full duplexing. As an example, the uplink rate matching pattern may indicate certain resource blocks to rate match around for mapping frequency resources. That is, the rate matching pattern may represent resources to exclude while selecting resources for the first signal. In certain cases, the uplink rate matching pattern may have a periodicity, such that the resources associated with the rate matching pattern may repeat over time with a specific period. That is, the rate matching pattern may be periodic in time. With respect to the operations 500, the configuration may include an indication of one or more frequency resources to rate match around in mapping frequency resources for the first signal. At block 506, the UE may configure the resources based at least in part on the indication. The UE may map frequency resources for the first signal around the frequency resources indicated in the configuration, for example, as described herein with respect to FIG. 7. In other words, the UE may select resources for the first signal that do not include the resources associated with the rate matching pattern. At block 508, the UE may transmit the first signal in the transmission occasion via the configured resources, which are the resources selected for transmission taking into account the rate matching pattern. The configured resources may refer to the resources selected for transmission of the first signal and/or reception of the second signal. For the first signal, the configured resources may be resources from an uplink resource assignment except for the resources associated with the rate matching pattern that overlap with the uplink resource assignment. That is, the configured resources for the first signal exclude the resources associated with the rate matching pattern that overlap with the resources assigned to the first signal. The indication may further indicate a periodicity in time associated with the frequency resources for rate matching, and the frequency resources may include one or more resource blocks.

In aspects, the network entity may indicate a reference signal resource set to rate match around, for example, when scheduling the uplink transmission to the UE in full duplexing. The UE may rate match the indicated reference signal resource set (e.g., a CSI-RS resource set) when transmitting the uplink signal. In other words, the reference signal resource set may be associated with a specific reference signal, where avoiding interference may provide desirable measurement accuracy, such as positioning reference signal. The reference signal resource set may be a nonzero power CSI-RS resource or zero power CSI-RS resource. The UE may rate match the overlapping part between the indicated CSI-RS resource and the uplink transmission. With respect to the operations 500, the configuration may include an indication of a reference signal resource set to rate match around in mapping frequency resources for the first signal. The UE may configure the resources based at least in part on the indication. For example, the UE may rate match around the reference signal resource set when mapping frequency resources for the first signal. At block 508, the UE may transmit the first signal in the transmission occasion via the configured resources. For the first signal, the configured resources may be the resources from the uplink resource assignment, except for the resources associated with the reference signal resource set that overlap with the uplink resource assignment. That is, the configured resources for the first signal exclude the resources associated with the reference signal resource set that overlap with the resources assigned to the first signal. The reference signal resource set may include one or more reference signal resources. The reference signal resources may include at least one of a zero-power channel state information reference signal (ZP-CSI-RS) resources or a non-zero power channel state information reference signal (NZP-CSI-RS) resource.

For certain aspects, the network entity may indicate a specific downlink signal and/or channel to rate match around, for example, when scheduling the uplink transmission to the UE in full duplexing. That is, when UE is scheduled with an uplink transmission in a full duplexing mode simultaneously with a certain predetermined downlink signal or channel, the UE may rate match around the certain downlink signals or channels without additional indication from the network. For example, the UE will perform rate matching on the uplink transmission to exclude the overlapping resources with a positioning CSI-RS (PRS) resources on the downlink, when the uplink transmission and the PRS is scheduled simultaneously. In certain cases, the UE will perform rate matching on the uplink transmission to exclude specific resources in a bandwidth part associated with a channel flagged for rate matching, such as a PDSCH or PDCCH.

With respect to the operations 500, the configuration may include an indication of a signal or a channel to rate match around in mapping frequency resources for the first signal. The UE may configure the resources based at least in part on the indication, and the UE may transmit the first signal in the transmission occasion via the configured resources. In aspects, the signal may include a reference signal such as a positioning reference signal, and the channel may include a bandwidth part to rate match around in mapping frequency resources.

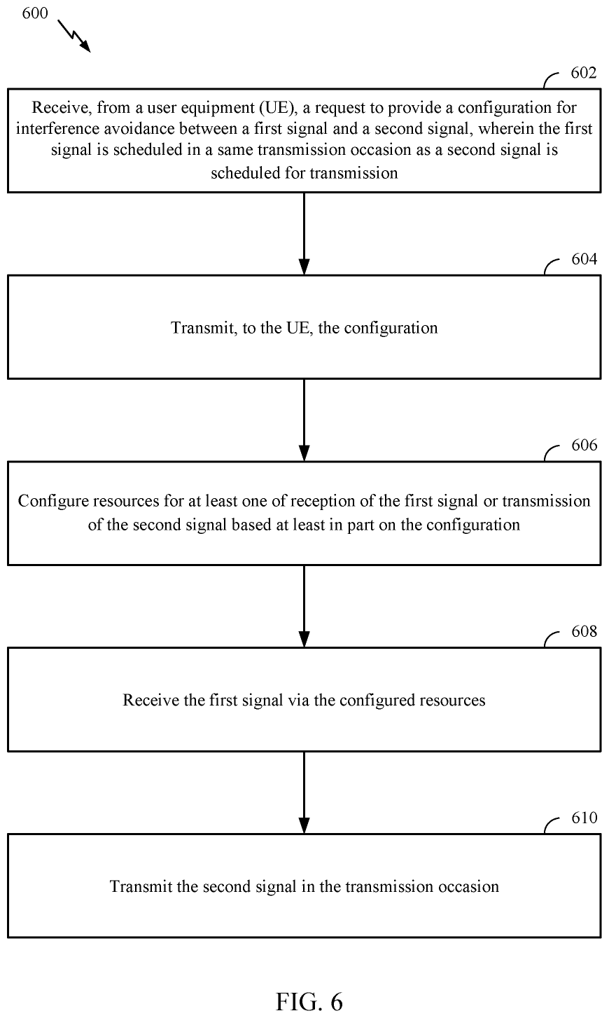

FIG. 6 is a flow diagram illustrating example operations 600 for wireless communication, in accordance with certain aspects of the present disclosure. The operations 600 may be performed, for example, by a network entity (such as the BS 110a in the wireless communication network 100). The operations 600 may be complementary to the operations 500 performed by the UE. The operations 600 may be implemented as software components that are executed and run on one or more processors (e.g., controller/processor 240 of FIG. 2). Further, the transmission and reception of signals by the network entity in operations 600 may be enabled, for example, by one or more antennas (e.g., antennas 234 of FIG. 2). In certain aspects, the transmission and/or reception of signals by the network entity may be implemented via a bus interface of one or more processors (e.g., controller/processor 240) obtaining and/or outputting signals. As used herein, the network entity may refer to a wireless communication device in a radio access network, such as a base station, a remote radio head or antenna panel in communication with a base station, and/or network controller.

The operations 600 may begin, at block 602, where the network entity may receive, from a UE, a request to provide a configuration for interference avoidance between a first signal and a second signal, where the first signal is scheduled in a same transmission occasion as the second signal is scheduled for transmission. For example, the request may be a request for spatial separation between the first and second signals.

At block 604, the network entity may transmit, to the UE, the configuration. For example, the configuration may provide the spatial separation requested by the UE, such as an indication of separate AoAs and/or AoDs for the first and second signals.

At block 606, the network entity may configure resources for at least one of reception of the first signal or transmission of the second signal based at least in part on the configuration. For example, the network entity may map frequency resources for the first signal by rate matching around the frequency resources allocated for the second signal.

At block 608, the network entity may receive the first signal via the configured resources. In certain cases, the network entity may receive the first signal in a different transmission occasion, such that the full duplex communications are temporarily paused between the UE and the network entity during the transmission occasion, which may avoid self-interference for the second signal.

At block 610, the network entity may transmit the second signal in the transmission occasion. For example, the network entity may transmit a positioning reference signal in the transmission occasion.

In aspects, the request at block 602 may indicate the transmission occasion (e.g., in terms of symbols or one or more slots), a specific signal (e.g., a reference signal), and/or a channel or portion of channel in which interference avoidance is requested.

For certain aspects, the UE may request a time restriction for a network entity to not schedule any uplink transmission on certain full duplex symbols. The request may indicate a time restriction to not schedule the first signal in the same transmission occasion with the second signal, and in response, the configuration may indicate another transmission occasion for the first signal. At block 610, the network entity may receive the first signal in the other transmission occasion.

In certain aspects, the UE may request for more separation between the downlink reception and the uplink transmission on full duplex symbols. For example, at block 602, the network entity may receive a request that indicates to provide separation between the first signal and the second signal, and in response at block 604, the network entity may send a configuration that indicates the separation between the first signal and the second signal. At block 610, the network entity may receive the first signal in the transmission occasion with the separation indicated in the configuration, such as frequency separation, spatial separation, and/or enabling rate matching, as described herein with respect to FIG. 5.

In aspects, the UE may request for a guard band and/or frequency separation between the uplink and downlink signals. At block 602, the network entity may receive a request that indicates to provide frequency separation between the first signal and the second signal, and in response at block 604, the network entity may send a configuration that indicates the frequency separation between the first signal and the second signal. At block 610, the network entity may receive the first signal in the transmission occasion with the frequency separation indicated in the configuration. The frequency separation may include one or more guard bands in the frequency domain between the first signal and the second signal. The frequency separation between the first and second signals may enable full duplex communications that mitigate or avoid interference at the UE.

In certain aspects, the UE may request for an adjustment of the SDM (e.g., beamforming) associated with the uplink and downlink signals. At block 602, the network entity may receive a request that indicates to adjust a SDM associated with the first signal and the second signal, and in response at block 604, the network entity may send a configuration that indicates a spatial parameter (e.g., an AoA or AoD) for at least the first signal. The spatial parameter may enable the UE to transmit the first signal using a beamforming that mitigates or avoids interference with the second signal. The network entity may receive the first signal in the transmission occasion based at least in part the spatial parameter indicated in the configuration.

For certain aspects, the UE may request that rate matching be enabled for mapping frequency resources for the uplink signal. At block 602, the network entity may receive a request that indicates to enable rate matching in a frequency domain for the first signal around the second signal, and in response at block 604, the network entity may send a configuration that indicates that rate matching is enabled for the first signal. The network entity may receive the first signal in the transmission occasion via one or more frequency resources rate matched around the second signal.

In certain aspects, the network entity may indicate an uplink rate matching pattern for the UE, for example, as described herein with respect to FIG. 5. At block 604, the network entity may send a configuration including an indication of one or more frequency resources to rate match around in mapping frequency resources for the first signal. In aspects, the indication may further indicate a periodicity in time associated with the frequency resources. That is, the rate matching pattern may include periodic frequency resources, for example, as described herein with respect to FIG. 7. In aspects, the frequency resources associated with the rate matching pattern may include one or more resource blocks, such as resource blocks in a specific bandwidth part.

In aspects, the network entity may indicate a reference signal resource set to rate match around, for example, as described herein with respect to FIG. 5. At block 604, the network entity may send a configuration including an indication of a reference signal resource set to rate match around in mapping frequency resources for the first signal. The reference signal resource set may include one or more reference signal resources, and the reference signal resources may include at least one of a ZP-CSI-RS resource or a NZP-CSI-RS resource.

For certain aspects, the network entity may indicate a specific downlink signal and/or channel to rate match around, for example, as described herein with respect to FIG. 5. At block 604, the network entity may send a configuration including an indication of a signal or a channel to rate match around in mapping frequency resources for the first signal. In aspects, the signal for rate matching may include a positioning reference signal. The channel may include a bandwidth part of a carrier to rate match around in mapping frequency resources.

FIG. 7 is a diagram illustrating an example of uplink rate matching in a full duplex transmission occasion (e.g., slot 3), in accordance with certain aspects of the present disclosure. In this example, a UE may be configured with downlink resources 702a, 702b for rate matching. For example, the downlink resources 702a, 702b may be associated with a rate matching pattern, a reference signal resource set, a specific downlink signal, and/or a specific channel or portion of a channel for uplink rate matching. The downlink resources 702a, 702b may be arranged in the same frequency resources in a periodic pattern over time. The downlink resources 702a, 702b are arranged in slots 1 and 3, and each of the downlink resources 702a, 702b may occupy a certain number of symbol(s) and/or a certain number of resource block(s) the respects slots. The UE may receive uplink scheduling 704 (e.g., a DCI message) in slot 2 for an uplink transmission. The uplink scheduling 704 may provide an uplink resource assignment for uplink resources 706 in slot 3. The uplink resources 706 may overlap with the second instance 702b of the downlink resources 702a, 702b. In this example, all of the downlink resources 702b overlap with a portion of the uplink resources 706. That is, the uplink resources 706 partially overlap with the downlink resources 702b. In certain cases, the downlink resource 702b may partially overlap with the uplink resources 706.

With the rate matching configuration, the UE may rate match around the downlink resources 702b in configuring the uplink resources 706 for transmission. That is, the UE may select the uplink resources 706 that do not overlap with the downlink resources 702b for the uplink transmission, and the resources selected from the uplink resources 706 that do not overlap with the downlink resources 702b may be considered the configured resources used for the uplink transmission. The uplink rate matching may facilitate mitigation or avoidance of interference encountered in receiving a downlink signal via the downlink resources 702b at the UE.

While this example is described with respect to multiple instances of downlink resources being configured for uplink rate matching and the downlink resources being periodic in time, aspects of the present disclosure may also apply to an individual instance of downlink resources being configured for uplink rate matching and/or the downlink resources being aperiodic in time. For example, the UE may be configured with separate occasions for downlink resources flagged for uplink rate matching. In certain cases, a reference signal flagged for rate matching may be aperiodic, and an aperiodic trigger may indicate to the UE when to perform uplink rate matching around the resources assigned for the aperiodic reference signal.

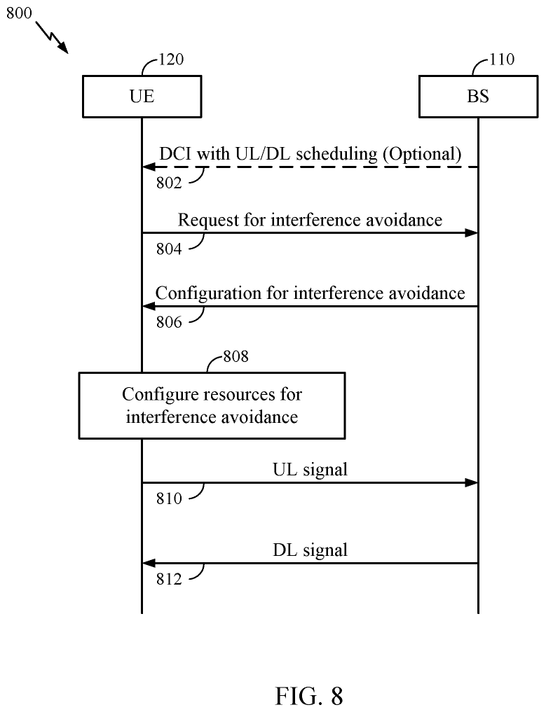

FIG. 8 is a signaling flow diagram illustrating example signaling for configuring resources to avoid interference in full duplex communications, in accordance with certain aspects of the present disclosure. At 802, the UE 120 may receive, from the BS 110, scheduling for an uplink transmission and/or a downlink transmission. The scheduling may be received via one or more DCI messages, and the scheduling may indicate a time domain and/or frequency domain resource assignment for the transmission(s).

At 804, the UE 120 may send, to the BS 110, a request for a configuration that provides interference avoidance between the downlink and uplink transmissions. In certain cases, the request may be sent in response to the scheduling received at 802. For example, suppose the UE 120 is scheduled to receive a reference signal at a particular transmission occasion, and the scheduling at 802 provides an uplink resource assignment that overlaps with the reference signal transmission in the transmission occasion. At 804, the UE 120 may request for frequency separation between the uplink transmission and the downlink reference signal to facilitate a desirable signal quality of the downlink reference signal.

At 806, the UE 120 may receive a configuration for the interference avoidance. For example, the configuration may provide the frequency separation requested at 804. In certain cases, the configuration may indicate to enable uplink rate matching for the downlink frequency resources that overlap with the uplink frequency resources. The configuration may provide the indications (such as a rate matching pattern, a reference signal resource set, a specific signal, and/or a specific channel or frequency resources) for uplink rate matching as described herein with respect to FIG. 5. In certain cases, the UE 120 may receive the configuration unprompted by the request. That is, the request may be an optional message sent to the network entity. For example, the UE 120 may receive the configuration via RRC signaling and/or system information.

At 808, the UE 120 may configure resources for at least one of transmission of the uplink signal or reception of the downlink signal in response to receiving the configuration. For example, the UE 120 may map frequency resources for the uplink signal around the frequency resources assigned to the downlink resources.

At 810, the UE 120 may transmit the uplink signal to the network entity in a transmission occasion, and at 812, the UE 120 may receive the downlink signal from the network entity in the same transmission occasion or a different transmission occasion. The UE 120 may apply the interference avoidance indicated in the configuration, which may provide frequency separation, a spatial configuration (e.g., beamforming), and/or uplink rate matching.

It will be appreciated that the various methods for interference avoidance described herein are merely examples, and other methods for interference avoidance may be performed at the UE to provide desirable signal quality for downlink signals in certain full duplex communications.

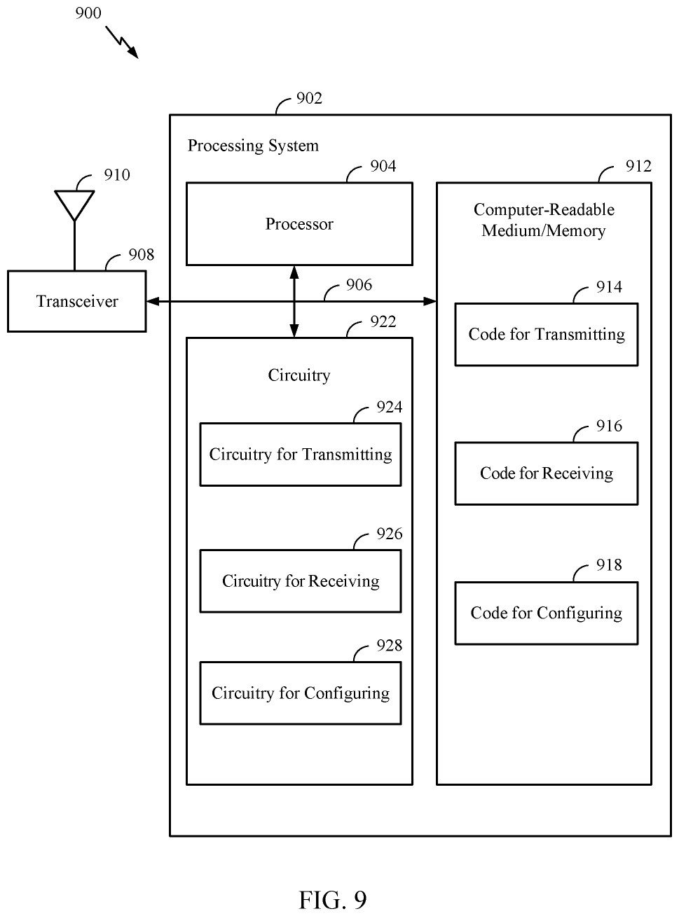

FIG. 9 illustrates a communications device 900 (e.g., a user equipment or a base station) that may include various components (e.g., corresponding to means-plus-function components) configured to perform operations for the techniques disclosed herein, such as the operations illustrated in FIG. 5 and/or FIG. 6. The communications device 900 includes a processing system 902 coupled to a transceiver 908 (e.g., a transmitter and/or a receiver). The transceiver 908 is configured to transmit and receive signals for the communications device 900 via an antenna 910, such as the various signals as described herein. The processing system 902 may be configured to perform processing functions for the communications device 900, including processing signals received and/or to be transmitted by the communications device 900.

The processing system 902 includes a processor 904 coupled to a computer-readable medium/memory 912 via a bus 906. In certain aspects, the computer-readable medium/memory 912 is configured to store instructions (e.g., computer-executable code) that when executed by the processor 904, cause the processor 904 to perform the operations illustrated in FIG. 5 and/or FIG. 6, or other operations for performing the various techniques discussed herein for performing interference avoidance in full duplex communications. In certain aspects, computer-readable medium/memory 912 stores code for transmitting 914, code for receiving 916, and/or code for configuring 918. In certain aspects, the processing system 902 has circuitry 922 configured to implement the code stored in the computer-readable medium/memory 912. In certain aspects, the circuitry 922 is coupled to the processor 904 and/or the computer-readable medium/memory 912 via the bus 906. For example, the circuitry 922 includes circuitry for transmitting 924, circuitry for receiving 926, and/or circuitry for configuring 928.

### Example Aspects

In addition to the various aspects described above, specific combinations of aspects are within the scope of the disclosure, some of which are detailed below:

Aspect 1: A method of wireless communication by a user equipment, comprising: transmitting, to a network entity, a request to provide a configuration for interference avoidance between a first signal and a second signal, wherein the first signal is scheduled in a same transmission occasion as the second signal is scheduled for reception; receiving, from the network entity, the configuration; configuring resources for at least one of transmission of the first signal or reception of the second signal in response to receiving the configuration; transmitting the first signal via the configured resources; and receiving the second signal in the transmission occasion.

Aspect 2: The method of Aspect 1, wherein: the request indicates a time restriction to not schedule the first signal in the same transmission occasion with the second signal; the configuration indicates another transmission occasion for the first signal; and transmitting the first signal comprises transmitting the first signal in the other transmission occasion.

Aspect 3: The method according to any of Aspects 1 or 2, wherein: the request indicates to provide separation between the first signal and the second signal; the configuration indicates the separation between the first signal and the second signal; and transmitting the first signal comprises transmitting the first signal in the transmission occasion with the separation indicated in the configuration.

Aspect 4: The method of Aspect 3, wherein: the request indicates to provide frequency separation between the first signal and the second signal; the configuration indicates the frequency separation between the first signal and the second signal; and transmitting the first signal comprises transmitting the first signal in the transmission occasion with the frequency separation indicated in the configuration.

Aspect 5: The method of Aspect 4, wherein the frequency separation includes one or more guard bands between the first signal and the second signal.

Aspect 6: The method according to any of Aspects 3-5, wherein: the request indicates to adjust a space division multiplexing (SDM) associated with the first signal and the second signal; the configuration indicates a spatial parameter for at least the first signal; and transmitting the first signal comprises transmitting the first signal in the transmission occasion based at least in part on the spatial parameter indicated in the configuration.

Aspect 7: The method according to any of Aspects 3-6, wherein: the request indicates to enable rate matching in a frequency domain for the first signal around the second signal; the configuration indicates that rate matching is enabled for the first signal; and transmitting the first signal comprises transmitting the first signal in the transmission occasion via one or more frequency resources rate matched around the second signal.

Aspect 8: The method according to any of Aspects 1-7, wherein: the configuration comprises an indication of one or more frequency resources to rate match around in mapping frequency resources for the first signal; configuring the resources comprises configuring the resources based at least in part on the indication; and transmitting the first signal comprises transmitting the first signal in the transmission occasion via the configured resources.

Aspect 9: The method of Aspect 8, wherein the indication further indicates a periodicity in time associated with the one or more frequency resources.

Aspect 10: The method according to any of Aspects 8 or 9, wherein the one or more frequency resources include one or more resource blocks.

Aspect 11: The method according to any of Aspects 1-10, wherein: the configuration comprises an indication of a reference signal resource set to rate match around in mapping frequency resources for the first signal; configuring the resources comprises configuring the resources based at least in part on the indication; and transmitting the first signal comprises transmitting the first signal in the transmission occasion via the configured resources.

Aspect 12: The method of Aspect 11, wherein the reference signal resource set includes one or more reference signal resources.

Aspect 13: The method of Aspect 12, wherein one or more the reference signal resources includes at least one of a zero-power channel state information reference signal (ZP-CSI-RS) resource or a non-zero power channel state information reference signal (NZP-CSI-RS) resource.

Aspect 14: The method according to any of Aspects 1-12, wherein: the configuration comprises an indication of a signal or a channel to rate match around in mapping frequency resources for the first signal; and configuring the resources comprises configuring the resources based at least in part on the indication; and transmitting the first signal comprises transmitting the first signal in the transmission occasion via the configured resources

Aspect 15: The method of Aspect 14, the signal includes a positioning reference signal.

Aspect 16: The method according to any of Aspects 14 or 15, the channel includes a bandwidth part to rate match around in mapping frequency resources.

Aspect 17: A method of wireless communication by a network entity, comprising: receiving, from a user equipment (UE), a request to provide a configuration for interference avoidance between a first signal and a second signal, wherein the first signal is scheduled in a same transmission occasion as the second signal is scheduled for transmission; transmitting, to the UE, the configuration; and configuring resources for at least one of reception of the first signal or transmission of the second signal based at least in part on the configuration; receiving the first signal via the configured resources; and transmitting the second signal in the transmission occasion.

Aspect 18: The method of Aspect 17, wherein: the request indicates a time restriction to not schedule the first signal in the same transmission occasion with the second signal; the configuration indicates another transmission occasion for the first signal; and receiving the first signal comprises receiving the first signal in the other transmission occasion.

Aspect 19: The method according to any of Aspects 17 or 18, wherein: the request indicates to provide separation between the first signal and the second signal; the configuration indicates the separation between the first signal and the second signal; and receiving the first signal comprises receiving the first signal in the transmission occasion with the separation indicated in the configuration.

Aspect 20: The method of Aspect 19, wherein: the request indicates to provide frequency separation between the first signal and the second signal; the configuration indicates the frequency separation between the first signal and the second signal; and receiving the first signal comprises receiving the first signal in the transmission occasion with the frequency separation indicated in the configuration.

Aspect 21: The method of Aspect 20, wherein the frequency separation includes one or more guard bands between the first signal and the second signal.

Aspect 22: The method according to any of Aspects 19-21, wherein: the request indicates to adjust a space division multiplexing (SDM) associated with the first signal and the second signal; the configuration indicates a spatial parameter for at least the first signal; and receiving the first signal comprises receiving the first signal in the transmission occasion based at least in part the spatial parameter indicated in the configuration.

Aspect 23: The method according to any of Aspects 19-22, wherein: the request indicates to enable rate matching in a frequency domain for the first signal around the second signal; the configuration indicates that rate matching is enabled for the first signal; and receiving the first signal comprises receiving the first signal in the transmission occasion via one or more frequency resources rate matched around the second signal.

Aspect 24: The method according to any of Aspects 17-23, wherein: the configuration comprises an indication of one or more frequency resources to rate match around in mapping frequency resources for the first signal; configuring the resources comprises configuring the resources based at least in part on the indication; and receiving the first signal comprises receiving the first signal in the transmission occasion via the configured resources.

Aspect 25: The method of Aspect 24, wherein the indication further indicates a periodicity in time associated with the one or more frequency resources.

Aspect 26: The method according to any of Aspects 24 or 25, wherein the one or more frequency resources includes one or more resource blocks.

Aspect 27: The method according to any of Aspects 17-26, wherein: the configuration comprises an indication of a reference signal resource set to rate match around in mapping frequency resources for the first signal; configuring the resources comprises configuring the resources based at least in part on the indication; and receiving the first signal comprises receiving the first signal in the transmission occasion via the configured resources.

Aspect 28: The method of Aspect 27, wherein the reference signal resource set includes one or more reference signal resources.

Aspect 29: The method of Aspect 28, wherein one or more the reference signal resources includes at least one of a zero-power channel state information reference signal (ZP-CSI-RS) resource or a non-zero power channel state information reference signal (NZP-CSI-RS) resource.

Aspect 30: The method according to any of Aspects 17-29, wherein: the configuration comprises an indication of a signal or a channel to rate match around in mapping frequency resources for the first signal; and configuring the resources comprises configuring the resources based at least in part on the indication; and receiving the first signal comprises receiving the first signal in the transmission occasion via the configured resources.

Aspect 31: The method of Aspect 30, the signal includes a positioning reference signal.

Aspect 32: The method according to any of Aspects 30 or 31, the channel includes a bandwidth part of a carrier to rate match around in mapping frequency resources.

Aspect 33: An apparatus, comprising: a memory comprising executable instructions; one or more processors configured to execute the executable instructions and cause the apparatus to perform a method in accordance with any one of Aspects 1-32.

Aspect 34: An apparatus, comprising means for performing a method in accordance with any one of Aspects 1-32.

Aspect 35: A computer-readable medium comprising executable instructions that, when executed by one or more processors of an apparatus, cause the apparatus to perform a method in accordance with any one of Aspects 1-32.

Aspect 36: A computer program product embodied on a computer-readable storage medium comprising code for performing a method in accordance with any one of Aspects 1-32.

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another. In other words, unless a specific order of steps or actions is specified, the order and/or use of specific steps and/or actions may be modified.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, a digital signal processor (DSP), an application specific integrated circuit (ASIC), or a processor (e.g., a general purpose or specifically programmed processor). Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above can also be considered as examples of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 5 and/or FIG. 6.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above.

1. An apparatus for wireless communication, comprising:
a transmitter configured to transmit, to a network entity, a request to provide a configuration for interference avoidance between a first signal and a second signal, wherein the first signal is scheduled in a same transmission occasion as the second signal is scheduled for reception;
a receiver configured to receive, from the network entity, the configuration;
a memory; and
a processor coupled to the memory, the processor being configured to execute instructions stored in the memory that cause the apparatus to configure resources for at least one of transmission of the first signal or reception of the second signal in response to receiving the configuration, wherein the transmitter is further configured to transmit the first signal via the configured resources, and wherein the receiver is further configured to receive the second signal in the transmission occasion.

2. The apparatus of claim 1, wherein:
the request indicates a time restriction to not schedule the first signal in the same transmission occasion with the second signal;
the configuration indicates another transmission occasion for the first signal; and
the transmitter is further configured to transmit the first signal in the other transmission occasion.

3. The apparatus of claim 1, wherein:
the request indicates to provide separation between the first signal and the second signal;
the configuration indicates the separation between the first signal and the second signal; and
the transmitter is further configured to transmit the first signal in the transmission occasion with the separation indicated in the configuration.

4. The apparatus of claim 3, wherein:
the request indicates to provide frequency separation between the first signal and the second signal;
the configuration indicates the frequency separation between the first signal and the second signal; and
the transmitter is further configured to transmit the first signal in the transmission occasion with the frequency separation indicated in the configuration.

5. The apparatus of claim 3, wherein:
the request indicates to adjust a space division multiplexing (SDM) associated with the first signal and the second signal;
the configuration indicates a spatial parameter for at least the first signal; and
the transmitter is further configured to transmit the first signal in the transmission occasion based at least in part on the spatial parameter indicated in the configuration.

6. The apparatus of claim 3, wherein:
the request indicates to enable rate matching in a frequency domain for the first signal around the second signal;
the configuration indicates that rate matching is enabled for the first signal; and
the transmitter is further configured to transmit the first signal in the transmission occasion via one or more frequency resources rate matched around the second signal.

7. The apparatus of claim 1, wherein:
the configuration comprises an indication of one or more frequency resources to rate match around in mapping frequency resources for the first signal;
the processor and the memory are further configured to configure the resources based at least in part on the indication; and
the transmitter is further configured to transmit the first signal in the transmission occasion via the configured resources.

8. The apparatus of claim 7, wherein the indication further indicates a periodicity in time associated with the one or more frequency resources.

9. The apparatus of claim 1, wherein:
the configuration comprises an indication of a reference signal resource set to rate match around in mapping frequency resources for the first signal;
the processor and the memory are further configured to configure the resources based at least in part on the indication; and
the transmitter is further configured to transmit the first signal in the transmission occasion via the configured resources.

10. The method of claim 9, wherein the reference signal resource set includes at least one of a zero-power channel state information reference signal (ZP-CSI-RS) resource or a non-zero power channel state information reference signal (NZP-CSI-RS) resource.

11. The apparatus of claim 1, wherein:
the configuration comprises an indication of a signal or a channel to rate match around in mapping frequency resources for the first signal; and
the processor and the memory are further configured to configure the resources based at least in part on the indication; and
the transmitter is further configured to transmit the first signal in the transmission occasion via the configured resources

12. An apparatus for wireless communication, comprising:
a receiver configured to receive, from a user equipment (UE), a request to provide a configuration for interference avoidance between a first signal and a second signal, wherein the first signal is scheduled in a same transmission occasion as the second signal is scheduled for transmission;
a transmitter configured to transmit, to the UE, the configuration;
a memory;
a processor coupled to the memory, the processor and the memory being configured to configure resources for at least one of reception of the first signal or transmission of the second signal based at least in part on the configuration, wherein the receiver is further configured to receive the first signal via the configured resources, and the transmitter is further configured to transmit the second signal in the transmission occasion.

13. The apparatus of claim 12, wherein:
the request indicates a time restriction to not schedule the first signal in the same transmission occasion with the second signal;
the configuration indicates another transmission occasion for the first signal; and
the receiver is further configured to receive the first signal in the other transmission occasion.

14. The apparatus of claim 12, wherein:
the request indicates to provide separation between the first signal and the second signal;
the configuration indicates the separation between the first signal and the second signal; and
the receiver is further configured to receive the first signal in the transmission occasion with the separation indicated in the configuration.

15. The apparatus of claim 14, wherein:
the request indicates to provide frequency separation between the first signal and the second signal;
the configuration indicates the frequency separation between the first signal and the second signal; and
the receiver is further configured to receive the first signal in the transmission occasion with the frequency separation indicated in the configuration.

16. The apparatus of claim 14, wherein:
the request indicates to adjust a space division multiplexing (SDM) associated with the first signal and the second signal;
the configuration indicates a spatial parameter for at least the first signal; and
the receiver is further configured to receive the first signal in the transmission occasion based at least in part the spatial parameter indicated in the configuration.

17. The apparatus of claim 14, wherein:
the request indicates to enable rate matching in a frequency domain for the first signal around the second signal;
the configuration indicates that rate matching is enabled for the first signal; and
receiving the first signal comprises receiving the first signal in the transmission occasion via one or more frequency resources rate matched around the second signal.

18. The apparatus of claim 12, wherein:
the configuration comprises an indication of one or more frequency resources to rate match around in mapping frequency resources for the first signal;
the processor and the memory are further configured to configure the resources based at least in part on the indication; and
the receiver is further configured to receive the first signal in the transmission occasion via the configured resources.

19. The apparatus of claim 24, wherein the indication further indicates a periodicity in time associated with the one or more frequency resources.

20. The apparatus of claim 12, wherein:
the configuration comprises an indication of a reference signal resource set to rate match around in mapping frequency resources for the first signal;
the processor and the memory are further configured to configure the resources based at least in part on the indication; and
the receiver is further configured to receive the first signal in the transmission occasion via the configured resources.

21. The apparatus of claim 20, wherein the reference signal resource set includes at least one of a zero-power channel state information reference signal (ZP-CSI-RS) resource or a non-zero power channel state information reference signal (NZP-CSI-RS) resource.

22. The apparatus of claim 12, wherein:
the configuration comprises an indication of a signal or a channel to rate match around in mapping frequency resources for the first signal; and
the processor and the memory are further configured to configure the resources based at least in part on the indication; and
the receiver is further configured to receive the first signal in the transmission occasion via the configured resources.

23. A method of wireless communication by a user equipment, comprising:
transmitting, to a network entity, a request to provide a configuration for interference avoidance between a first signal and a second signal, wherein the first signal is scheduled in a same transmission occasion as the second signal is scheduled for reception;
receiving, from the network entity, the configuration;
configuring resources for at least one of transmission of the first signal or reception of the second signal in response to receiving the configuration;
transmitting the first signal via the configured resources; and
receiving the second signal in the transmission occasion.

24. The method of claim 23, wherein:
the request indicates to provide separation between the first signal and the second signal;
the configuration indicates the separation between the first signal and the second signal; and
transmitting the first signal comprises transmitting the first signal in the transmission occasion with the separation indicated in the configuration.

25. The method of claim 23, wherein:
the configuration comprises an indication of one or more frequency resources to rate match around in mapping frequency resources for the first signal;
configuring the resources comprises configuring the resources based at least in part on the indication; and
transmitting the first signal comprises transmitting the first signal in the transmission occasion via the configured resources.

26. The method of claim 23, wherein:
the configuration comprises an indication of a reference signal resource set to rate match around in mapping frequency resources for the first signal;
configuring the resources comprises configuring the resources based at least in part on the indication; and
transmitting the first signal comprises transmitting the first signal in the transmission occasion via the configured resources.

27. The method of claim 23, wherein:
the configuration comprises an indication of a signal or a channel to rate match around in mapping frequency resources for the first signal; and
configuring the resources comprises configuring the resources based at least in part on the indication; and
transmitting the first signal comprises transmitting the first signal in the transmission occasion via the configured resources

28. A method of wireless communication by a network entity, comprising:
receiving, from a user equipment (UE), a request to provide a configuration for interference avoidance between a first signal and a second signal, wherein the first signal is scheduled in a same transmission occasion as the second signal is scheduled for transmission;
transmitting, to the UE, the configuration; and
configuring resources for at least one of reception of the first signal or transmission of the second signal based at least in part on the configuration;
receiving the first signal via the configured resources; and
transmitting the second signal in the transmission occasion.

29. The method of claim 28, wherein:
the request indicates to provide separation between the first signal and the second signal;
the configuration indicates the separation between the first signal and the second signal; and
receiving the first signal comprises receiving the first signal in the transmission occasion with the separation indicated in the configuration.

30. The method of claim 28, wherein:
the configuration comprises an indication of one or more frequency resources to rate match around in mapping frequency resources for the first signal;
configuring the resources comprises configuring the resources based at least in part on the indication; and
receiving the first signal comprises receiving the first signal in the transmission occasion via the configured resources.
